(19) United States
(12) Patent Application Publication
(10) Pub. No.: US 2012/0005618 A1
(43) Pub. Date: Jan. 5, 2012

(54) SUBFORMS

(75) Inventors: Michael N. Tofinetti, Kanata (CA); Katha Kulasingam, Kanata (CA); David Kiesekamp, Merrickville (CA)

(73) Assignee: ALCATEL-LUCENT CANADA INC., Kanata (CA)

(21) Appl. No.: 12/827,575

(22) Filed: Jun. 30, 2010

(51) Int. Cl. G06F 3/048

(52) U.S. Cl. 715/777

(57) ABSTRACT

A method is provided for displaying subforms in a perspective having areas and portlets. An entity represented by a portlet is configured using a form within the portlet. Sub-entities may require configuration as part of configuring the first entity. When a user configures a sub-entity, a subform is opened presenting means of configuring the sub-entity. The subform overlays most of the parent form, making the parent form inaccessible until configuration of the sub-entity is either accepted or cancelled. Using subforms, it is apparent to a user that configuration of the first entity is not complete until all related sub-entities have also been configured. Use of subforms within a portlet also allows other information necessary for configuration of the entity or sub-entities to be viewed by the user.

### FIELD OF THE INVENTION

This invention relates to graphical user interfaces, and more particularly to a method of displaying multiple pieces of information.

### BACKGROUND OF THE INVENTION

Management of customer information in telecommunication networks often requires the presentation of many pieces of information. For example, information related to billing rates and expected levels of service must be presented to an administrator so that the administrator can obtain current information or can edit information stored in a database. The information may be presented as lines of text, but a graphical user interface allows an administrator to select various items, to more easily view the current state of the selected items, and to more easily change the information related to the selected items.

The flexibility given to the administrator may come at a cost, however. As the administrator selects different views of the information, different aspects of the information presented to the administrator in different windows may become difficult to manage, especially when the administrator starts moving the windows around. For example, the administrator may wish to view information concerning a particular subscriber in a telecommunication network. A Listing window is used to find existing subscribers or to create new ones. Individual subscribers are created or edited in forms specific to the subscriber data. These forms contain many fields, such as category, user identifier, description, a list of subscription identifiers, custom data, and a list of called station identifiers. Each of these called station identifiers contains a large amount of information dealing with Quality of Service (QoS) parameters: defaults, aggregate maximum bit rates, guaranteed bit rates, maximum bit rates for QoS classes, associated AF applications, and custom data. Many of these are lists which open up configuration forms of their own. In addition, there is a separate search facility to find a subscriber by a specific subscription identifier. This is a search window which opens on top of the subscriber list.

U.S. patent application Ser. No. 12/707,865, entitled “Perspective View”, filed on Feb. 18, 2010, and incorporated herein, provides a solution to presenting many pieces of data. Information is presented in portlets organized within areas such that different portlets can be selected easily. The areas form a perspective, such that different areas, and hence different portlets, can be viewed simultaneously.

Configuration of an entity represented by a portlet may require data for nested elements of the entity to be entered. One solution would be to use pop-up forms for each set of configuration data. However the parent form and the child form used in such a solution are not tightly coupled. If one is moved around on a display screen, the relationship between the two forms is not readily apparent. The pop-up form may be made modal so that changes made to the pop-up form must be accepted or cancelled before performing any other operations in the system, but this prevents an operator from consulting additional information before completing the form.

A method of displaying information which preserved the obviousness of the relationship between forms yet was not modal would allow a user to more easily and quickly configure entities.

### SUMMARY OF THE INVENTION

According to one aspect, the invention provides a method of displaying a graphical user interface. A perspective is displayed, the perspective having at least one area. Within each area, at least one portlet tab is displayed, each such portlet tab being associated with a corresponding portlet. Within each area, the portlet associated with a selected one of the at least one portlet tab within the area is displayed. Within one of the portlets which is displayed, a form representing an entity to be configured is displayed, the form containing a first body containing a first list of at least one sub-entity to be configured before configuration of the entity is complete. When an entry in the first list is selected, a first subform representing configuration information for the corresponding sub-entity is displayed such that the first subform overlays the first body.

In one embodiment, the first subform includes an accept button. Upon selection of the accept button, if all required configuration information for the corresponding sub-entity is present then the first subform is closed and the configuration information for the sub-entity is applied to the entity represented by the form. However, if all configuration information for the corresponding sub-entity is not present, an error message is displayed.

In another embodiment, the first subform has a second body containing a second list of at least one further sub-entity to be configured before configuration of the sub-entity corresponding to the first subform is considered complete. A second subform representing required configuration information for the corresponding further sub-entity is displayed such that the second subform overlays the second body when an entry in the second list is selected.

The methods of the invention may be stored as processing instructions on computer-readable storage media, the instructions being executable by a computer processor.

By using subforms, entities containing nested elements can be more easily configured. A parent form cannot be accessed while a subform is being completed, thereby indicating clearly when an entity and all its sub-elements have been configured. Yet both the parent form and subforms are moved or resized together, allowing access to other portlets in order to determine information which may be useful in completing the subform.

### BRIEF DESCRIPTION OF THE DRAWINGS

The features and advantages of the invention will become more apparent from the following detailed description of the preferred embodiment(s) with reference to the attached figures, wherein:

FIG. 1 is a diagram of an example perspective;

FIG. 2 is a diagram of an example area;

FIG. 3 is a diagram of an example portlet according to one embodiment of the invention;

FIG. 4 is a diagram of the portlet of FIG. 3 when a subform is opened according to one embodiment of the invention; and

FIG. 5 is a diagram of the portlet of FIG. 3 when yet a further subform is opened according to one embodiment of the invention

It is noted that in the attached figures, like features bear similar labels.

### DETAILED DESCRIPTION OF THE PREFERRED EMBODIMENTS

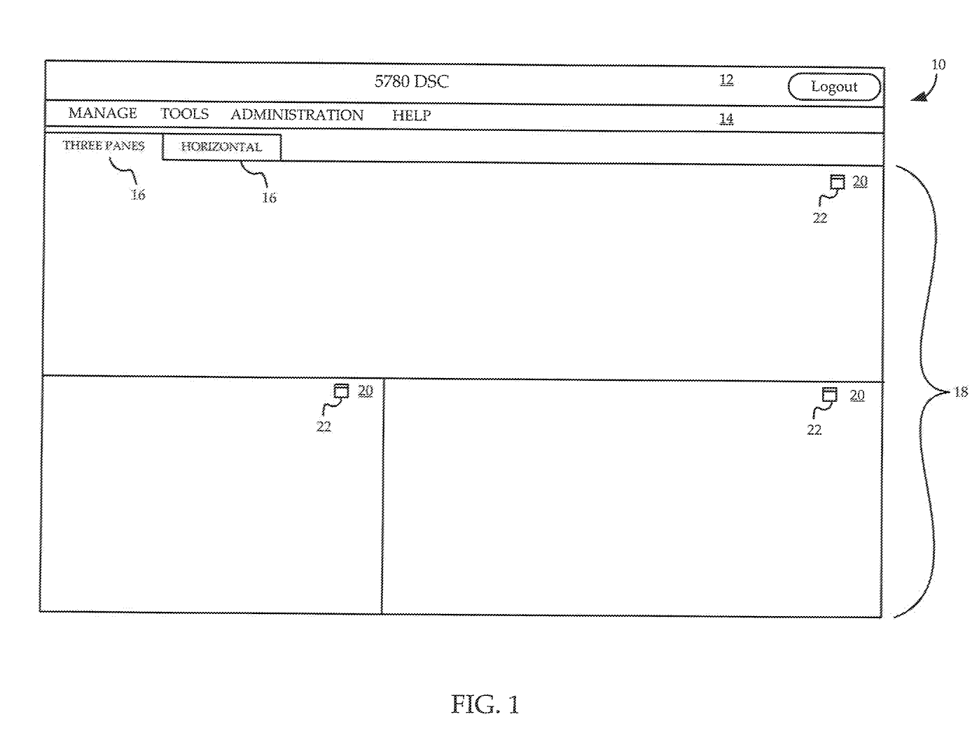

Referring to FIG. 1, a diagram of an example perspective is shown. At the top level a user is presented with an application interface 10. Preferably, the application interface 10 occupies the entire display area of a display device. The application interface 10 includes a title bar 12, a menu bar 14, one or more tabs 16 called “perspective tabs”, and one or more stacked views called “perspectives” 18. Each perspective tab 16 has an associated perspective 18, and selecting one of the perspective tabs makes the perspective 18 associated with that perspective tab visible. Each perspective is an overall view of some aspect of information. Only one perspective is displayed, but if more than one perspective is available then the user can select a particular perspective to be displayed using the perspective tabs. In the example shown in FIG. 1, the user can select between two perspectives. The available perspectives may be either predefined or may be generated by the user. Generation of a perspective by a user provides flexibility in what data the user sees or interacts with.

Each perspective contains at least one pane, termed an “area”. In the example shown in FIG. 1, the perspective 18 contains three areas 20. Within a displayed perspective 18, the areas 20 may be resized but in general may not be created or destroyed. In other words, the number of areas within each perspective is normally fixed, but more generally a user may create one or more areas within a perspective. The definition of each area includes the types of portlet (described below) permitted in the area, in other words the types of portlet that can exist or be created within the area. Each area has two list definitions for this purpose, one of which lists the types of portlets which can be created within the area and one of which lists the types of portlets which can exist within the area. Either list may indicate that all portlet types can be created or are allowed, either by explicitly listing all the portlet types or by listing a special value. For example, the list of types of portlets which can exist within an area may be empty, which indicates that all types of portlets can exist within the area. Examples of types of portlets are Lists, Forms, and Trees.

Each area also has a maximize icon 22 for maximizing the area to occupy the entire perspective view, at which point a normalize icon (not shown in FIG. 1) becomes visible or selectable for restoring the area to its normal size. For certain purposes, as described below, the areas are ordered.

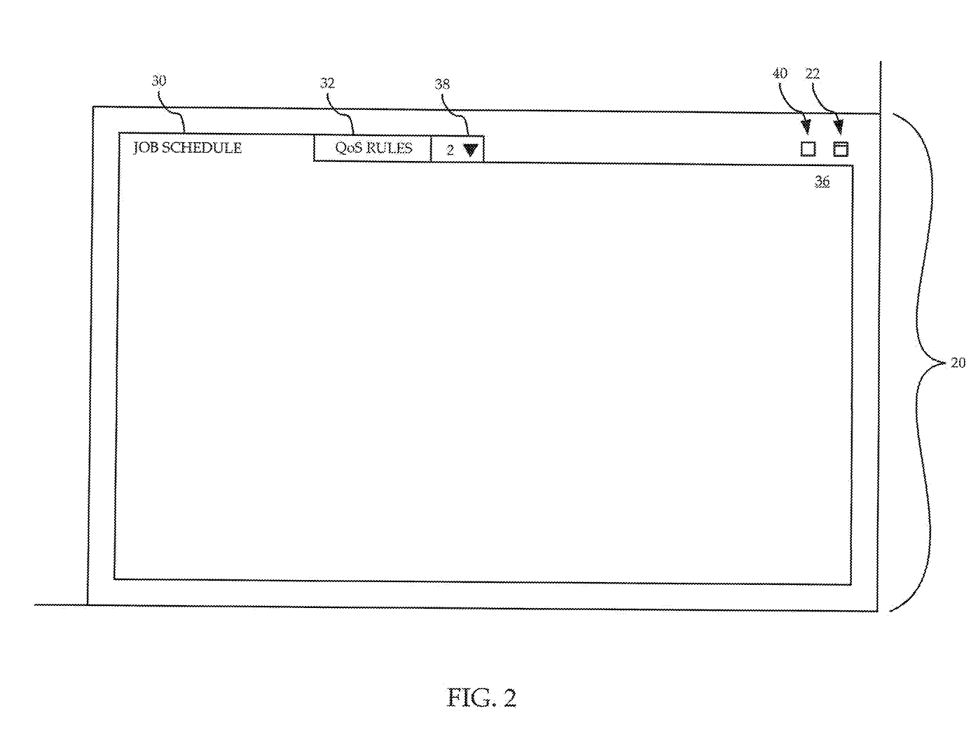

Referring to FIG. 2, a diagram of an example area 20 according to one embodiment of the invention is shown. The area may include at least one tab 30 and 32 called a “portlet tab”, and at least one stacked panel called a “portlet” 36. If a portlet tab is not visible due to width constraints of the area in which the portlet tab would otherwise be present, then a drop-down list 38 containing identifications of additional portlets is used. Each portlet tab and if present each item in the drop-down list has an associated portlet, and selecting one of the portlet tabs or an item in the drop-down list makes the portlet 36 associated with that portlet tab or item visible. Each portlet is a display of information, either information directly from a database or derived from information in the database. Only one portlet is displayed within each area, but if more than one portlet is available then the user can select a particular portlet to be displayed using the portlet tabs or drop-down list within the area. In the example shown in FIG. 2, the user can select between four portlets in the area, although selection of a portlet for viewing in an area does not affect which portlets are selectable or visible in other areas.

The area includes a save button 40. When the save button 40 is selected, information for the entity represented by the portlet that is visible is saved so as to persist in a data retrieval system, such as a database. One means by which this information is entered is described below.

Each portlet presents information of a type specific to that portlet. A portlet can be a list of information or a form presenting current information and allowing the current information to be changed.

Portlets can be destroyed in an area and can be added to an area. A portlet can also be moved between areas by clicking and dragging the portlet to a destination area, as long as the type of portlet is allowed in the destination area as indicated by the list of types of portlets which can exist within the area.

Broadly, a form is displayed within one of the portlets, the form representing an entity to be configured. The form contains a first body containing a first list of at least one sub-entity to be configured before configuration of the entity is complete. When an entry in the first list is selected, a first subform representing required configuration information for the corresponding sub-entity is displayed such that the first subform overlays the first body. The first subform may include an accept button and upon selection of the accept button, if all required configuration information for the corresponding sub-entity is present then the first subform is closed and the configuration information for the sub-entity is applied to the entity represented by the form. If on the other hand all required configuration information for the corresponding sub-entity is not present, an error message is displayed. The first subform has a second body which may contain a second list of at least one further sub-entity to be configured before configuration of the sub-entity corresponding to the first subform is considered complete. A second subform representing configuration information for the corresponding further sub-entity is displayed such that the second subform overlays the second body when an entry in the second list is selected.

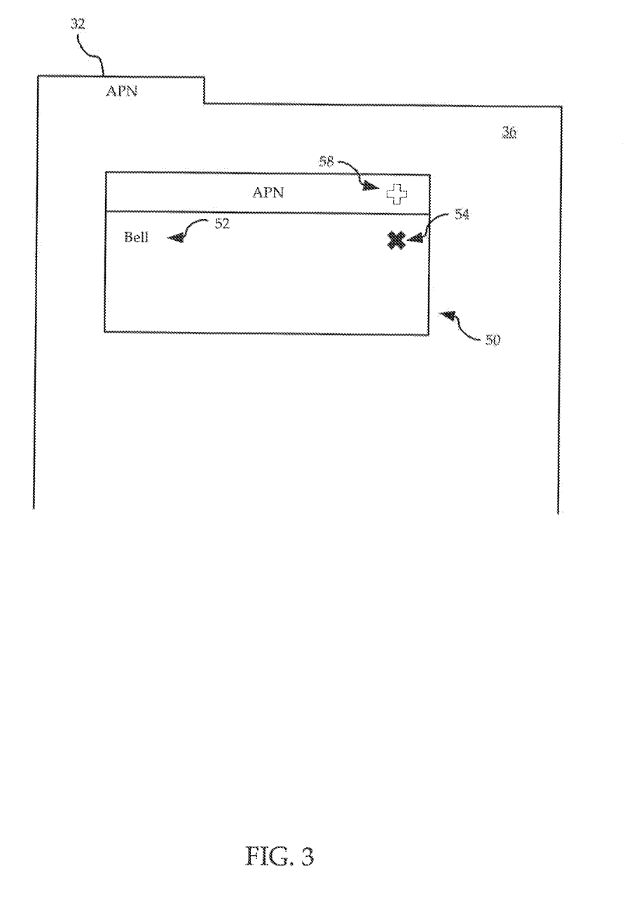

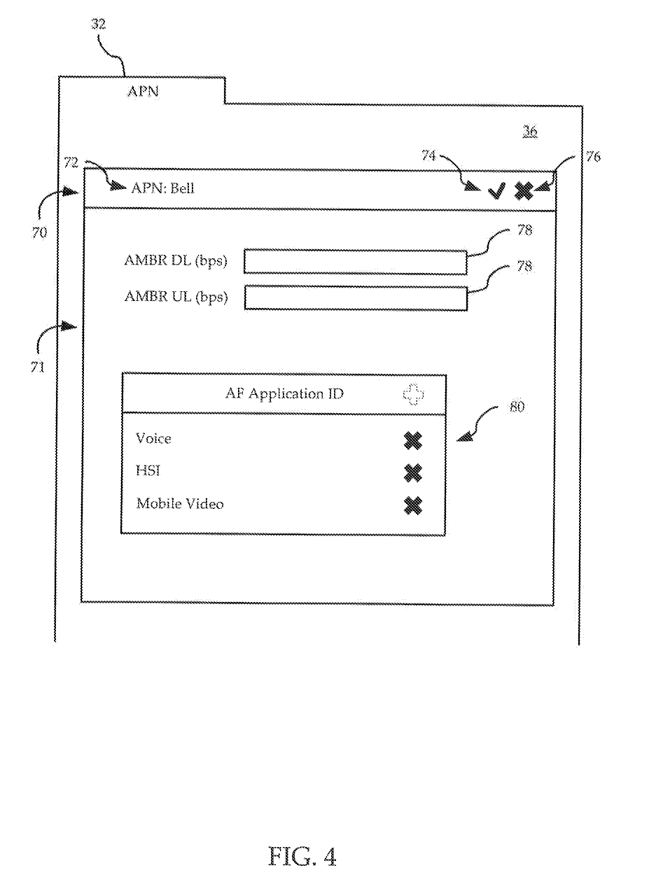

Referring to FIG. 3, a portion of an example portlet according to one embodiment of the invention is shown. The portlet contains a list 50 which may contain entities which can be configured. In the example shown in FIG. 3 the list 50 contains only one entry, but more generally there will be at least zero entries in the list 50, and the list 50 may in fact be empty. Each entry in the list 50 includes an identifier 52 of the entity and a remove button 54. The list 50 also includes an add button 58. Selecting one of the identifiers 52, such as by double-clicking the identifier, opens a subform containing various widgets for configuring the entity represented by the entry to which the identifier belongs, as described below with reference to FIG. 4. Selecting one of the remove buttons 54 removes the entry from the list 50 of entities which can be configured. Selection of the add button 58 allows a new object to be added to the list 50, such as by opening a list portlet from which an entity can be selected for addition to the list 50, or by opening a new subform which allows fresh data for a new object to be entered.

Referring to FIG. 4, a portion of the example portlet of FIG. 3 according to one embodiment of the invention is shown. In the example shown in FIG. 4, the first entry has been selected for configuration in the version of the portlet shown in FIG. 3. The portlet presents a subform for completion by the user. The subform includes a title bar 70 and a body 71. The title bar 70 includes the name 72 of the entity for which the information in the subform relates, an accept button 74, and a cancel button 76. Within the body 71 of the subform, numerous entity names and widgets are present for entering information about the corresponding entity. The widgets shown in FIG. 4 include text entry fields 78, but more generally any type of widget or combination of widgets are present, such as enumerations, check boxes, and radio buttons. There will often be more information present than that shown in FIG. 4, but for simplicity only a few pieces of information are shown.

If sufficient information is present that the entity represented by the subform is fully configured, then selecting the accept button 74 applies the information present in the various widgets to the entity represented by the parent form and closes the subform, at which point the parent form becomes visible and accessible again. If there is not sufficient information present to fully configure the entity represented by the subform, then selecting the accept button 74 causes an error message to appear. Selecting the cancel button 76 also closes the subform making the parent form visible and accessible, but discards any changes made to the information in the various widgets of the subform.

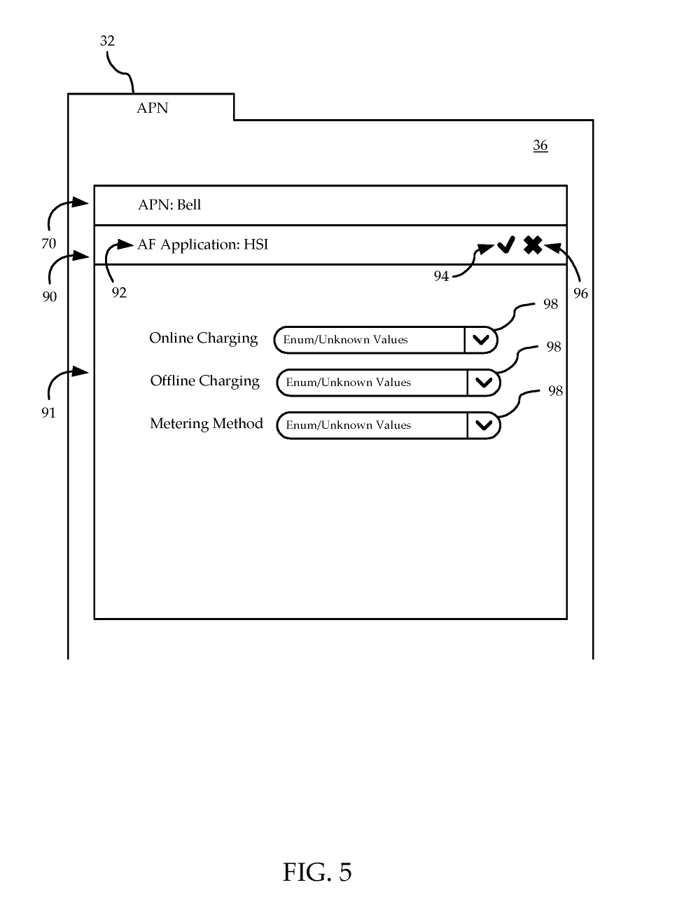

In the example shown in FIG. 4, the body of the subform includes a list 80 of additional entities which must each be fully configured before the entity represented by the subform (APN:Bell in FIG. 4) is considered to have sufficient information to indicate that configuration is complete. The list 80 behaves in the same way as the list 50 of the parent form, the icons and buttons being the same. Also similarly to the list 50 of the parent form, selecting one of the identifiers in the list 80 of the subform opens yet another subform revealing information and widgets needed for the configuration of the selected additional entity, as described below with reference to FIG. 5.

Referring to FIG. 5, a portion of the example portlet of FIG. 4 according to one embodiment of the invention is shown. In the example shown in FIG. 5, the second entry in the list 80 of FIG. 4 has been selected for configuration. The portlet presents yet another subform for completion by the user, the subform of FIG. 5 being a subform of the subform shown in FIG. 4. The subform of FIG. 5 includes a title bar 90 and a body 91. The title bar 90 includes the name 92 of the entity for which the information in the subform relates, an accept button 94, and a cancel button 96. The accept button 94 and the cancel button 96 act in the same way as the accept button 74 and the cancel button 76, respectively, of the subform shown in FIG. 4. The portlet also includes the title bar 70 of its parent form, but does not include the accept button 74 and the cancel button 76 of the form shown in FIG. 4. Alternatively, these buttons 74 and 76 may be present but are not selectable by the user at this point, and an indication that they are not selectable, such as by graying out the buttons 74 and 76, is displayed. In effect, the subform shown in FIG. 5 overlays most of the subform shown in FIG. 4, hiding the body 71 of the subform of FIG. 4. The subform of FIG. 4, and its title bar buttons 74 and 76 are only revealed and made selectable when the subform of FIG. 5 is closed, either by successfully selecting the accept button 94 or the cancel button 96.

Within the body 91 of the subform, numerous entity names and widgets are present for entering information about the corresponding entity. The widgets shown in FIG. 5 include enumerations 98, but more generally any type of widget or combination of widgets are present, such as text entry fields, check boxes, and radio buttons. There will often be more information present than that shown in FIG. 5, but for simplicity only a few pieces of information are shown.

The nesting of subforms within subforms can continue through as many levels as is necessary to fully configure the sub-entities contained within the main entity.

Since the portlet can be dragged to other areas or to a floating window, all forms and subforms associated with the entity and its sub-entities are moved as one, thereby preserving the link between the entity and its sub-entities. Similarly, selection of another portlet in the same area makes that other portlet visible and hides all the forms and subforms. Other portlets, containing information necessary for configuration of the entity, can therefore be viewed by manipulating the portlets, areas, and any floating windows.

The logic of the methods is preferably in the form of software, and may be stored as instructions on computer-readable storage media which can cause a computer processor to create subforms in the manner described herein. The information presented in the subforms may be information about customers in a telecommunication network, which may be obtained from a database, or may be any other sort of information.

The embodiments presented are exemplary only and persons skilled in the art would appreciate that variations to the embodiments described above may be made without departing from the spirit of the invention. For example, the various menus, title bars, and icons described above and shown in the figures are examples only, and other text and/or icons can be used. The scope of the invention is solely defined by the appended claims.

I/We claim:

1. A method of displaying a graphical user interface, comprising:
displaying one perspective;
within the perspective, displaying at least one area;
within each area, displaying at least one portlet tab, each such portlet tab being associated with a corresponding portlet;
within each area, displaying the portlet associated with a selected one of the at least one portlet tab within the area;
within one of the portlets which is displayed, displaying a form representing an entity to be configured, the form containing a first body containing a first list of at least one sub-entity to be configured before configuration of the entity is complete; and
when an entry in the first list is selected, displaying a first subform representing required configuration information for the corresponding sub-entity such that the first subform overlays the first body.

2. The method of claim 1 wherein the first subform includes an accept button, and wherein the method further comprises:
upon selection of the accept button, if all required configuration information for the corresponding sub-entity is present closing the first subform and applying the configuration information for the sub-entity to the entity; and
upon selection of the accept button, if all configuration information for the corresponding sub-entity is not present displaying an error message.

3. The method of claim 2 wherein the first subform includes a cancel button, and wherein the method further comprises closing the first subform without applying the configuration information for the sub-entity to the entity upon selection of the cancel button.

4. The method of claim 1 wherein the first subform has a second body containing a second list of at least one further sub-entity to be configured before configuration of the sub-entity corresponding to the first subform is considered complete, and wherein the method further comprises displaying a second subform representing required configuration information for the corresponding further sub-entity such that the second subform overlays the second body when an entry in the second list is selected.

5. The method claim 4 wherein the second subform has a third body, and wherein all bodies contain widgets used for entering or selecting information for configuration of the entity or sub-entity corresponding to the form or subform to which the body belongs.

6. The method of claim 1 wherein the first list includes an add button, and wherein a form portlet is opened for entering configuration information of a new sub-entity upon selection of the add button.
